(19) United States
(12) Patent Application Publication
(10) Pub. No.: US 2017/0318391 A1
(43) Pub. Date: Nov. 2, 2017

(54) DIAPHRAGM FOR SPEAKER APPARATUS

(71) Applicant: SLIVICE CO., LTD, Incheon (KR)

(72) Inventors: Han-Ryang LEE, Suwon-si (KR); Il-Kyung SUH, Incheon (KR)

(21) Appl. No.: 15/522,287

(22) PCT Filed: Nov. 9, 2015
(86) PCT No.: PCT/KR2015/011999

§ 371 Date: Apr. 27, 2017

(30) Foreign Application Priority Data
Nov. 8, 2014 (KR) 10-2014-0154827

(51) Int. Cl. H04R 7/12; G10K 13/00

(52) U.S. Cl. CPC H04R 7/12; G10K 13/00

(57) ABSTRACT

A diaphragm for a speaker apparatus according to the present invention, which has a major axis and a minor axis perpendicular thereto, comprises: an edge part coupled to a diaphragm edge or a frame and formed as a substantially flat surface; a convex part located inside the edge part and formed to be upwardly convex; and a concave part located inside the convex part and formed to be downwardly concave, wherein, with reference to the section in the direction of the minor axis, the height difference between the highest point of the convex part and the lowest point of the concave part in the central region is larger than the height difference between the highest point of the convex part and the lowest point of the concave part in the outer region in the direction of the major direction where the concave part starts.

### TECHNICAL FIELD

The present invention relates to a diaphragm for a speaker apparatus, and more particularly, to a diaphragm having a stiffness enhancing structure on the surface thereof to prevent an undesired vibration mode from occurring, thereby improving acoustic characteristics.

### BACKGROUND ART

The diaphragm used in the speaker apparatus is caused to vibrate by a speaker driver to generate a sound pressure. The speaker driver may include a voice coil and a magnetic circuit which generate up-and-down vibration by an electromagnetic force produced by interaction of a magnet and a current, a piezoelectric element which generates up-and-down vibration according to application of a voltage, or a condenser which generates an electric field by application of a voltage. The physical properties of the diaphragm determine acoustic characteristics of the speaker. In order to generate high quality sound, the diaphragm should be light in weight and have a high stiffness.

The weight of the diaphragm is related to the speaker efficiency. This relationship is checked through the Thiele/Small parameter, and the speaker efficiency is inversely proportional to the square of the weight of the vibration system including the diaphragm. As the weight of the diaphragm increases, the sound pressure level (SPL) of the speaker is lowered and the resonance frequency f₀ increases. On the contrary, as the weight of the diaphragm decreases, the SPL of the speaker is raised and thus louder sound can be generated, and the resonance frequency f₀ decreases, thereby enhancing the low frequency reproduction band.

Stiffness of the diaphragm is related to a frequency response characteristic of the speaker. Vibration of an ideal diaphragm is a piston motion in which the entire surface of the diaphragm moves uniformly up and down as a rigid body. However, mechanical analysis of vibration of a real diaphragm reveals abnormal vibrations such as the break-up mode and expansion on a part of the vibration plate. Such abnormal vibrations cause destructive interference at a specific frequency, resulting in an unfavorable frequency response characteristic, which causes acoustic distortion. Particularly, the problem of distortion of the frequency response characteristic is more noticeable in component speakers having different lengths in the vertical direction and the lateral direction. Component speakers used in electronic devices such as a television, a monitor, a notebook computer, a tablet, a smartphone, and a mobile communication terminal which include a display often have a plane of a rectangular shape with a major axis (in the lateral direction) and a minor axis (in the vertical direction) so as to be mounted on a bezel of the outermost part of the display and unseen. In this case, the length of the vibration path in the vertical direction is different from the length of the vibration path in the lateral direction, and different boundary conditions under which the surround is coupled are given in the vertical direction and the lateral direction. Accordingly, the component speakers have poorer frequency response characteristics than circular speakers or square speakers.

Stiffness of a general speaker material decreases as the weight of the material decreases, and increases as the weight increases. For example, when a metal diaphragm is used, it has an advantage in stiffness, and thus a relatively good frequency response characteristic can be obtained. However, the weight is increased, and the SPL and f₀ are reduced. Materials that can solve this problem include light metals such as aluminum, magnesium or duralumin, or new materials such as carbon fiber, glass fiber and Kevlar. These new materials are proper as diaphragm materials because they are light in weight but have high stiffness. However, these materials are expensive. That is, the new materials are suitable for diaphragms for expensive speakers for music listening, but not for use in low-cost component speakers.

Diaphragm materials for component speakers are generally low-priced paper or polymer films. These materials have the advantage of being light in weight but have a low stiffness.

FIG. 19 shows a diaphragm 10 for a component speaker apparatus according to the prior art. The diaphragm 10 includes an edge portion 11, a convex portion 12, and a concave portion 13. The diaphragm 10 is fabricated by applying press processing to paper of a certain thickness. The edge portion 11 is formed to be flat so as to be joined to the edge of an elastic material or to a speaker frame. The convex portion 12 is formed in an annular shape so as to be convex toward the sound generating surface of the diaphragm and to provide additional stiffness to the entire surface of the diaphragm 10. The concave portion 13 is formed inside the convex portion 12 and is formed to have the same height as the edge portion. Particularly, the concave portion 13 is formed to be flat so that the concave portion has the same height over the entire area thereof, and the highest point of the convex portion 12 is also formed to have the same height at all parts thereof.

According to such a conventional structure, since the diaphragm 10 is made of paper, the weight thereof is light, and the bending stiffness and the torsional stiffness of the diaphragm is somewhat enhanced by the convex portion 12. However, the effect of enhancing the stiffness is not sufficient with the convex portion 220 alone, and the problem of distortion of the acoustic characteristic caused by a resonance mode occurring at a resonance frequency due to the material characteristic of the diaphragm 10 still needs to be solved. Particularly, according to the prior art, it has been confirmed that, despite the stiffness enhanced by the convex portion 12, the diaphragm is very weak in suppressing the first resonance mode. For example, when an external force of 10 kPa is applied to the diaphragm 10 according to the prior art, it has been confirmed that the maximum displacement of the diaphragm is 11.292 mm at 215 Hz, at which the first resonance mode occurs. Further, severe sound distortion occurs at a frequency corresponding to a human hearing-sensitive area.

Prior art documents include U.S. Pat. No. 8,199,962, U.S. Pat. No. 6,026,929, and U.S. Pat. No. 2,960,177.

### DISCLOSURE

### Technical Problem

It is an aspect of the present invention to improve acoustic characteristics of a speaker apparatus by enhancing the stiffness of a diaphragm.

### Technical Solution

In accordance with one aspect of the present invention, a diaphragm for a speaker apparatus has a shape with a major axis and a minor axis perpendicular to the major axis and includes: an edge portion joined to a diaphragm edge or a frame and formed to be substantially planar; a convex portion positioned inside the edge portion and formed to be convex upward; and a concave portion positioned inside the convex portion and formed to be concave downward, wherein, in a cross section taken along the minor axis, a difference in height between a highest point of the convex portion and a lowest point of the concave portion in a central area is larger than a difference in height between the highest point of the convex portion and the lowest point of the concave portion in an outer area on the major axis from which the concave portion begins.

In the diaphragm for the speaker apparatus, a difference in height between the highest point of the convex portion and the lowest point of the concave portion at a position where the difference in height between the highest point of the convex portion and the lowest point of the concave portion is the smallest may be less than 30% of a difference in height between the highest point of the convex portion and the lowest point of the concave portion at a position where the difference in height between the highest point of the convex portion and the lowest point of the concave portion is the largest.

In the diaphragm for the speaker apparatus, in the cross section taken along the minor axis, the difference in height between the highest point of the convex portion and the lowest point of the concave portion may be reduced from the central area to an outer side along the major axis.

In the diaphragm for the speaker apparatus, in the cross section taken along the minor axis, the height of the highest point of the convex portion in the central area may be greater than the height of the highest point of the convex portion in the outer area on the major axis from which the concave portion begins.

In the diaphragm for the speaker apparatus, in the cross section taken along the minor axis, the height of the highest point of the convex portion may decrease from the central area to an outer side along a major axis.

In the diaphragm for the speaker apparatus, in the cross section taken along the minor axis, the height of the lowest point of the concave portion in the central area may be lower than the height of the lowest point of the concave portion in the outer area on the major axis from which the concave portion begins.

In the diaphragm for the speaker apparatus, in the cross section taken along the minor axis, the height of the lowest point of the concave portion may increase from the central area to an outer side along the major axis.

In the diaphragm for the speaker apparatus, the convex portion may be formed in a smooth curve shape having a convex central portion in a cross section taken along the major axis.

In the diaphragm for the speaker apparatus, the concave portion may be formed in a smooth curve shape having a concave central portion in a cross section taken along the major axis.

In the diaphragm for the speaker apparatus, the convex portion may include a first connector formed in a smooth curve shape from the edge portion to the highest point of the convex portion in the cross section taken along the minor axis.

In the diaphragm for the speaker apparatus, the concave portion may include a second connector having at least an interval formed in a smooth curve shape between the highest point of the convex portion and the lowest point of the concave portion in the cross section taken along the minor axis.

In the diaphragm for the speaker apparatus, the first connector may have a radius of curvature greater than a radius of curvature of the second connector in the central area in the cross section taken along the minor axis.

In the diaphragm for the speaker apparatus, the radius of curvature of the second connector may increase from the central area to an outer side along the major axis.

In the diaphragm for the speaker apparatus, the concave portion may include a second connector provided with a vertical surface portion in at least an interval from the highest point of the convex portion to the lowest point of the concave portion in the cross section taken along the minor axis.

In the diaphragm for the speaker apparatus, the lowest point of the concave portion in the cross section taken along the minor axis may be provided with a horizontal portion.

In the diaphragm for the speaker apparatus, the height of the lowest point of the concave portion may be greater than or equal to the height of the edge portion.

In the diaphragm for the speaker apparatus, the height of the lowest point of the concave portion in the central area may be equal to the height of the edge portion, and the height of the lowest point in areas other than the central area along the major axis may be greater than the height of the edge portion.

### Advantageous Effects

In a diaphragm for a speaker apparatus according to the present invention, the convex portion is formed to be higher at the center of the major axis than at the both ends of the major axis in order to provide enhanced stiffness to the diaphragm. Thereby, vibrations in the break-up mode and the resonance mode may be suppressed, and the acoustic characteristic of the speaker apparatus may be improved.

In a diaphragm for a speaker apparatus according to the present invention, the concave portion is formed to be lower at the center of the major axis than at the both ends of the major axis in order to provide enhanced stiffness to the diaphragm. Thereby, vibrations in the break-up mode and the resonance mode may be suppressed, and the acoustic characteristic of the speaker apparatus may be improved.

In a diaphragm for a speaker apparatus according to the present invention, the convex portion and the concave portion have shapes mutually opposed in the major axis direction so as to provide enhanced stiffness to the diaphragm. Thereby, vibrations in the break-up mode and the resonance mode may be suppressed, and the acoustic characteristic of the speaker apparatus may be improved.

### DESCRIPTION OF DRAWINGS

FIG. 1 is a top-side view of a diaphragm for a speaker apparatus according to a first embodiment of the present invention;

FIG. 2 is a bottom-side view of the diaphragm for the speaker apparatus according to the first embodiment of the present invention.

FIG. 3 is a top view of the diaphragm for the speaker apparatus according to the first embodiment of the present invention.

FIG. 4 is a side view of the diaphragm for the speaker apparatus according to the first embodiment of the present invention.

FIG. 5 is a cross-sectional view of the diaphragm for the speaker apparatus according to the first embodiment of the present invention, taken along line A-A′.

FIG. 6 is a detailed cross-sectional view of the diaphragm for the speaker apparatus according to the first embodiment of the present invention, taken along line A-A′.

FIG. 7 is a front view of the diaphragm for the speaker apparatus according to the first embodiment of the present invention;

FIG. 8 is a front sectional view of the diaphragm for the speaker apparatus according to the first embodiment of the present invention, taken along line B-B′.

FIG. 9 is a top-side view of a diaphragm for a speaker apparatus according to a second embodiment of the present invention.

FIG. 10 is a bottom-side view of the diaphragm for the speaker apparatus according to the second embodiment of the present invention.

FIG. 11 is a top view of the diaphragm for the speaker apparatus according to the second embodiment of the present invention.

FIG. 12 is a side view of the diaphragm for the speaker apparatus according to the second embodiment of the present invention.

FIG. 13 is a cross-sectional view of the diaphragm for the speaker apparatus according to the second embodiment of the present invention, taken along line A-A′.

FIG. 14 is a detailed cross-sectional view of the diaphragm for the speaker apparatus according to the second embodiment of the present invention, taken along line A-A′.

FIG. 15 is a front view of the diaphragm for the speaker apparatus according to the second embodiment of the present invention.

FIG. 16 is a front sectional view of the diaphragm for the speaker apparatus according to the second embodiment of the present invention, taken along line B-B′.

FIG. 17 is a graph depicting the maximum vibration displacements of a diaphragm for a speaker apparatus according to the prior art and a diaphragm for a speaker apparatus according to an embodiment of the present invention at respective frequencies.

FIG. 18 is a comparative table showing the maximum vibration displacements of a diaphragm for a speaker apparatus according to an embodiment of the present invention and a diaphragm for a speaker apparatus according to the prior art at respective frequencies.

FIG. 19 is a top-side view of a diaphragm for a speaker apparatus according to the prior art.

Reference numerals used herein are described below.

| | |
|---|---|
| 100: Diaphragm | 110: Edge portion |
| 120: Convex portion | 130: Concave portion |
| 132: Vertical surface portion | 134: Horizontal portion |

### BEST MODE

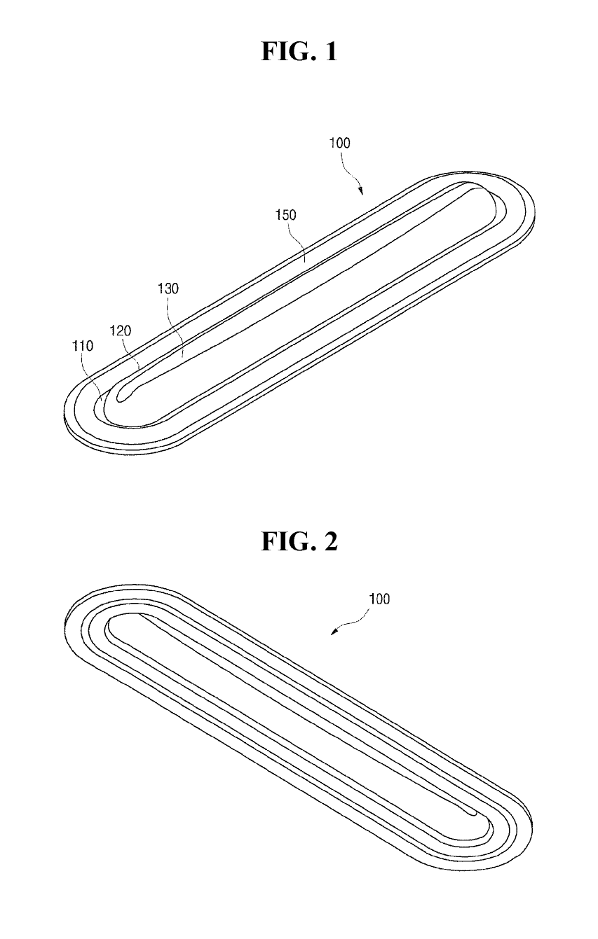

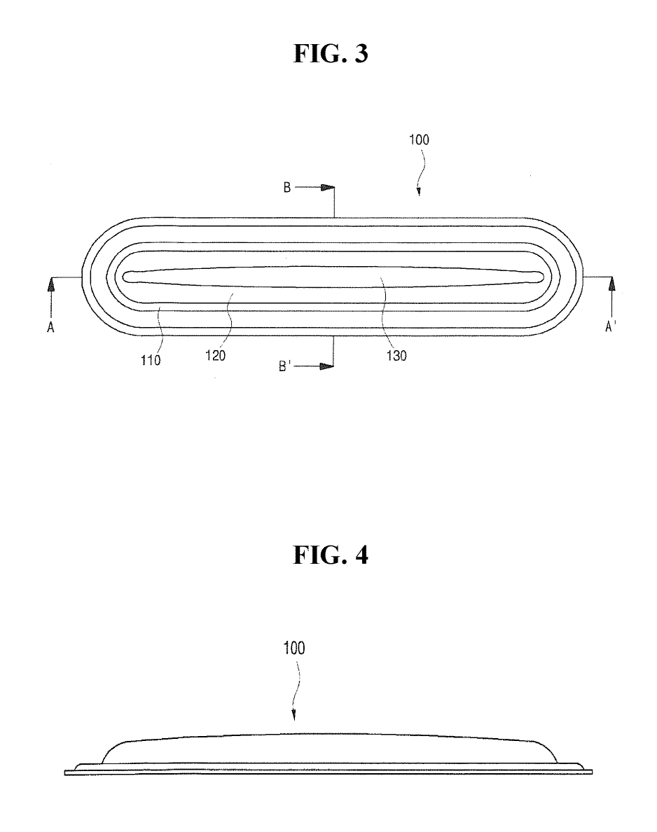

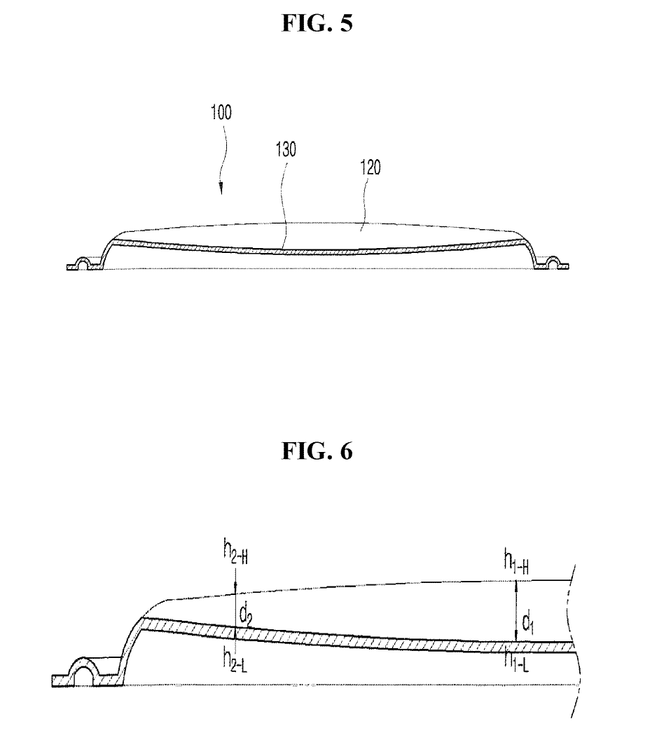

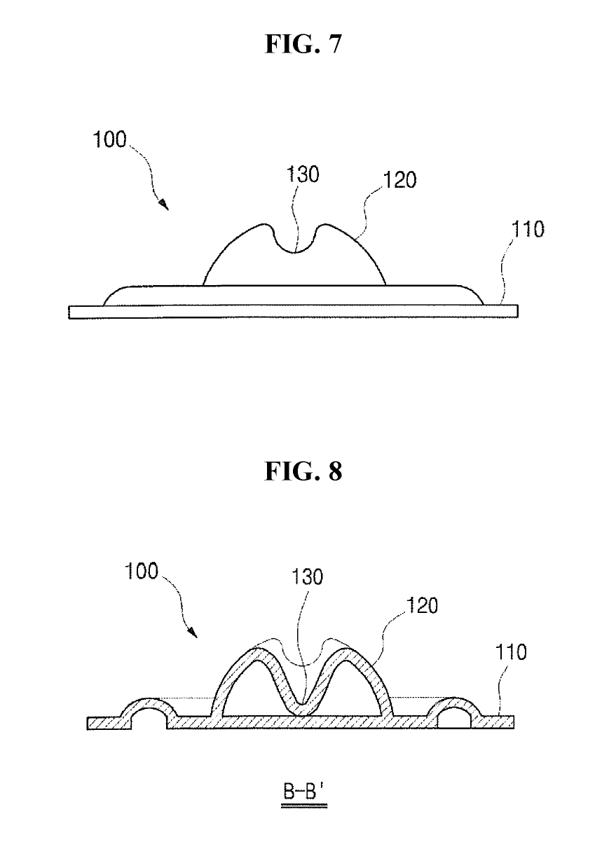

Hereinafter, a first embodiment of a diaphragm for a speaker apparatus according to the present invention will be described with reference to the drawings. FIG. 1 is a top-side view of a diaphragm for a speaker apparatus according to a first embodiment of the present invention, and FIG. 2 is a bottom-side view of the diaphragm according to the first embodiment of the present invention. FIG. 3 is a top view of the diaphragm according to the first embodiment of the present invention, FIG. 4 is a side view of the diaphragm according to the first embodiment of the present invention, and FIGS. 5 and 6 are cross-sectional views of the diaphragm according to the first embodiment of the present invention (taken along line A-A′). FIG. 7 is a front view of the diaphragm for the speaker apparatus according to the first embodiment of the present invention, and FIG. 8 is a front sectional view of the diaphragm according to the first embodiment of the present invention (taken along line B-B′).

Like the speaker apparatus according to the prior art, the diaphragm 100 for a speaker apparatus according to the first embodiment of the present invention includes an edge portion 110, a convex portion 120 and a concave portion 130.

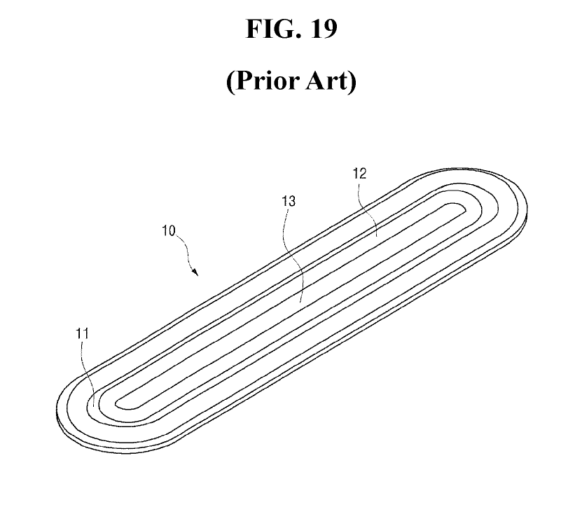

The diaphragm 100 has a rectangular or track shape having a major axis and a minor axis perpendicular to the major axis. Compared to a circular or square diaphragm, the diaphragm 100 is suitable to be mounted on a device including a display, but structurally provides a transmission path of vibration which is not uniform in the vibration direction, resulting in a break-up mode vibration and a poor frequency response characteristic. Therefore, an improved enhancing structure is required over the structure of the conventional diaphragm 10 shown in FIG. 19. The material of the diaphragm 100 is not particularly limited. When a material such as paper or a polymer film which has a relatively low stiffness is used, the frequency response characteristic may be greatly improved by a stiffness enhancing structure, which will described later. Of course, even when the stiffness enhancing structure according to the present invention is applied to the diaphragm 100 formed of a material with a relatively high stiffness such as stainless steel, aluminum, magnesium, duralumin, carbon fiber, glass fiber and Kevlar, the frequency response characteristic may be improved by additional enhancement of the stiffness.

The diaphragm 100 of the present invention is not limited to a dynamic speaker driven by a voice coil, but may be applied to speakers using other driving techniques including an electrostatic speaker or a piezo speaker.

The edge portion 110 is joined to the diaphragm edge or frame and is substantially formed to be flat. The diaphragm edge is generally formed of an elastic material such as a Thermoplastic Polyurethane (TPU). The diaphragm edge is joined to the edge portion 110 at the inner side thereof and jointed to the frame of the speaker apparatus through the bottom surface thereof, thereby functioning to provide damping force to the diaphragm 100. In another embodiment, the diaphragm 100 and the diaphragm edge may be integrally formed. In this case, the edge portion 110 may further include a diaphragm edge at the outermost periphery thereof. Further, in the case of a subminiature speaker such as a micro speaker, the diaphragm 100 may be directly joined to the frame of the speaker apparatus without a component corresponding to the diaphragm edge. Similar to the conventional diaphragm 200, the edge portion 110 may be formed to have the same height over the entire area thereof.

The convex portion 120 is positioned inside the edge portion and is formed to be convex upward of the sound generating surface of the diaphragm 100. In this specification, a surface of the speaker facing the outside is defined as an upper surface, and the direction pointing to the inside of the speaker is defined as the lower side.

The concave portion 130 is positioned inside the convex portion and is formed to be concave downward relatively to the convex portion 120.

Hereinafter, the shapes of the convex portion 120 and the concave portion 130 will be described in detail with reference to FIGS. 3 to 8. In this specification, “the highest point of the convex portion 120” does not mean the highest point on the entire convex portion 120, but refers to the highest point of the convex portion in a cross section taken along the minor axis (line B-B′). This is because the convex portion 120 in the cross section taken along the minor axis (line B-B′) may have a curve shape as a whole in some embodiments as shown in FIG. 8. Therefore, the highest point of the convex portion 120 varies depending on the position at which the cross section is taken along the minor axis (line B-B′). For the same reason, “the lowest point of the concave portion 130” does not mean the lowest point on the entire concave portion 130, but refers to the lowest point of the concave portion 130 in a cross section taken along the minor axis (line B-B′).

As shown in FIG. 6, in the cross section taken along the minor axis, the difference d₁ between the height h_{1-H} of the highest point of the convex portion 120 and the height h_{1-L} of the lowest point of the concave portion 130 in the central area is larger than the difference d₂ between the height h_{2-H} of the highest point of the convex portion 120 and the height h_{2-L} of the lowest point of the concave portion 130 in the outer area on the major axis from which the concave portion 130 begins to extend. According to this structure, since the stress due to the shape of the convex portion 120 and the stress due to the shape of the concave portion 130 cross each other and act on the front surface of the diaphragm 100, the structural stiffness, particularly, the bending stiffness and the torsional stiffness of the diaphragm 100 can be greatly enhanced.

Here, the position at which the smallest difference in height between the highest point of the convex portion 120 and the lowest point of the concave portion 130 is given is in the outer area on the major axis from which the concave portion 130 begins, and the position at which the largest difference in height between the highest point of the convex portion 120 and the lowest point of the concave portion 130 is given is in the central area on the major axis. As the difference between the differences in height at both positions increases, the stiffness of the diaphragm 100 may increase. However, if this difference is excessively large, the stiffness may be rather reduced and the manufacturing cost may increase due to a sudden change in curvature. Therefore, considering this feature, the smallest difference in height between the highest point of the convex portion 120 and the lowest point of the concave portion 130 is preferably set to be less than 30% of the largest difference d₁ in height.

Meanwhile, as shown in FIGS. 5 and 6, the difference in height between the highest point of the convex portion 120 and the lowest point of the concave portion 130 in the cross section taken along the minor axis (line B-B′) preferably decreases from the central area 141 to the outer area 142 along the major axis. As the height of the highest point of the convex portion 120 decreases from the central area 141 to the outer area 142, the convex portion 120 may be formed in the shape of a smooth convex curve having a convex central portion. On the other hand, as the height of the lowest point of the concave portion 130 increases from the central area 141 to the outer area 142, the concave portion 130 may be formed in the shape of a smooth concave curve having a concave central portion. However, the shape of the diaphragm 100 of the present invention is not limited thereto, and may be formed such that the highest points of the convex portion 120 or the lowest points of the concave portion 130 have the same height in a specific area or such that the highest point of the convex portion 120 or the lowest point of the concave portion 130 is changed in a certain step.

In some embodiments, the lowest points of the concave portion 130 may have the same height along the major axis, while the height of the highest point of the convex portion 120 in the central area is greater than the height of the highest point of the convex portion 120 in the outer area. Alternatively, the highest points of the convex portion 120 may have the same height along the major axis, while the height of the lowest point of the concave portion 130 in the central area is lower than the height of the highest point thereof in the outer area. According to these embodiments, the effect of enhancing the stiffness is reduced, compared to the embodiment in which both the concave portion 130 and the convex portion 120 are changed.

Hereinafter, the feature in shape of the cross section along the minor axis will be described. FIG. 7 is a front view of the diaphragm 100 according to an embodiment of the present invention, and FIG. 8 is a longitudinal sectional view taken along line B-B′ corresponding to the central portion of the diaphragm 100. The convex portion 120 may include a first connector formed to have a smooth curve shape from the edge portion 110 to the highest point of the convex portion 120 in the cross section along the minor axis, and the concave portion 130 may include a second connector formed in a smooth curve shape from the highest point of the convex portion 120 to the lowest point of the concave portion 130 in the cross section along the minor axis. The connectors may be formed in a rectilinear shape rather than the curve shape. However, considering convenience of manufacturing the diaphragm 100 and the durability of the diaphragm 100, the connectors are preferably formed in a curve shape as shown in FIGS. 7 and 8.

In this case, in the cross section along the minor axis in the central area, the radius of curvature of the first connector positioned on the outer side is preferably larger than the radius of curvature of the second connector positioned on the inner side. The stress analysis simulation result confirms that this shape provides a better effect of enhancing the stiffness.

Meanwhile, the radius of curvature of the central portion of the second connector connecting the convex portion 120 and the concave portion 130 may increase toward the outside. This structure allows the concave portion 130 at the central portion to have a steeper slope, so that the tension at the central portion, which is most likely to bend, becomes relatively large, thereby providing an effect of preventing the break-up mode vibration along the major axis.

The lowest point of the concave portion 130 is preferably formed to have the same height as or a greater height than the height of the edge portion 110 joined to the edge. In this case, the height of the lowest point of the concave portion 130 is preferably equal to the height of the edge portion 110 in the central area and is greater than the height of the edge portion 110 in the areas other than the central area. When the lowest point of the concave portion 130 is lower than the edge portion 110, a shape that is convex downward may be given to the bottom portion of the diaphragm 100 in an area corresponding to the concave portion 130. In the case of a dynamic speaker, the convex portion of the bottom surface may cause interference with the voice coil attached to the bottom surface of the diaphragm 100. Of course, in the case of an electrostatic speaker or a piezoelectric speaker in which no other component is attached to the bottom portion of the diaphragm 100, the lowest point of the recess 130 may be formed at a lower position than the edge portion 110.

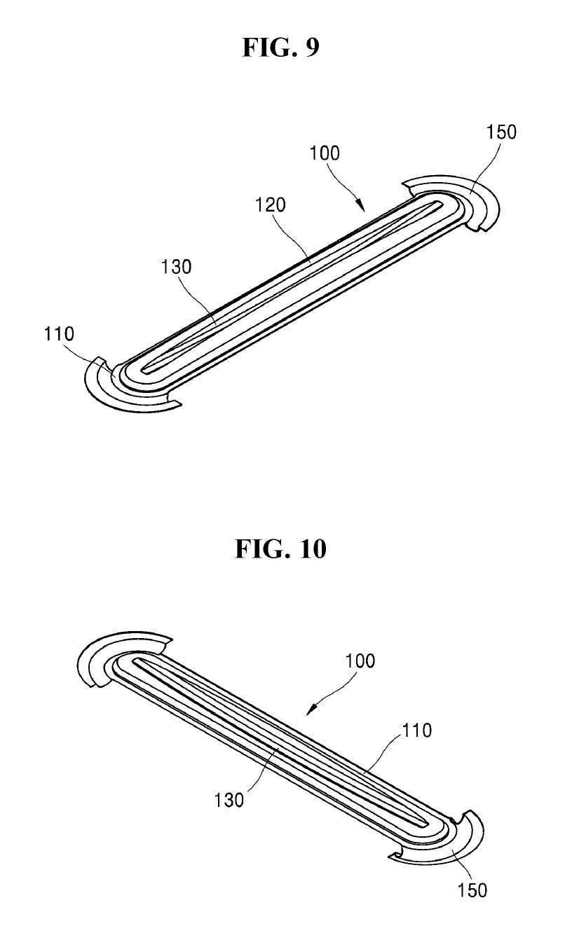

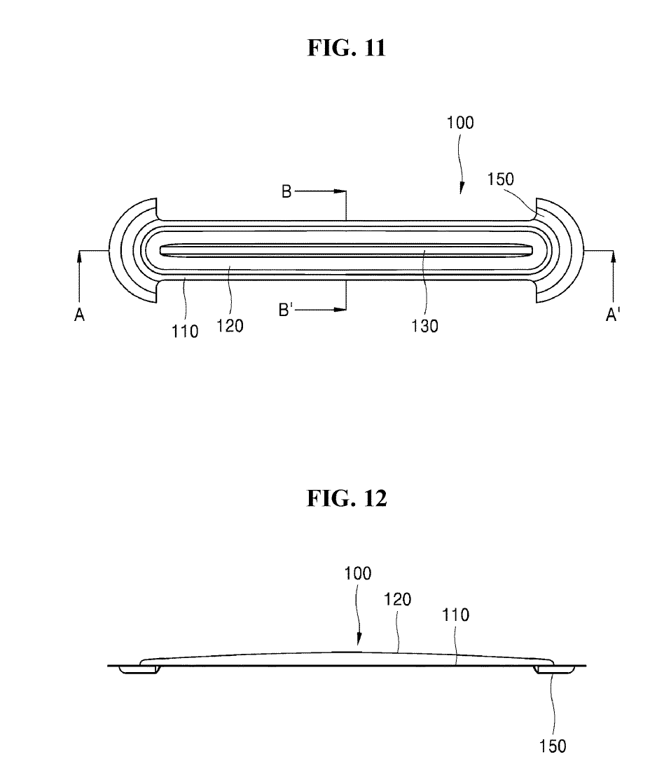

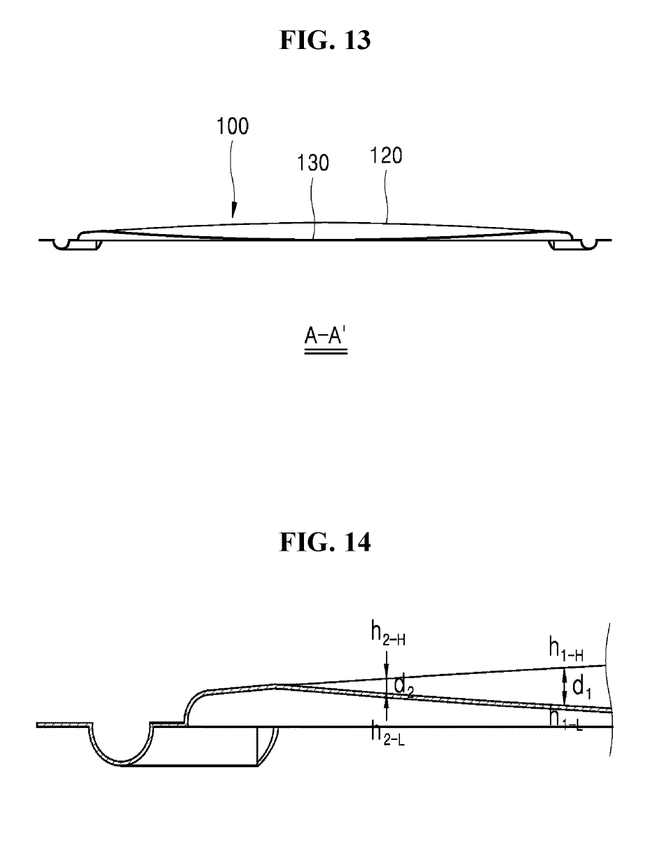

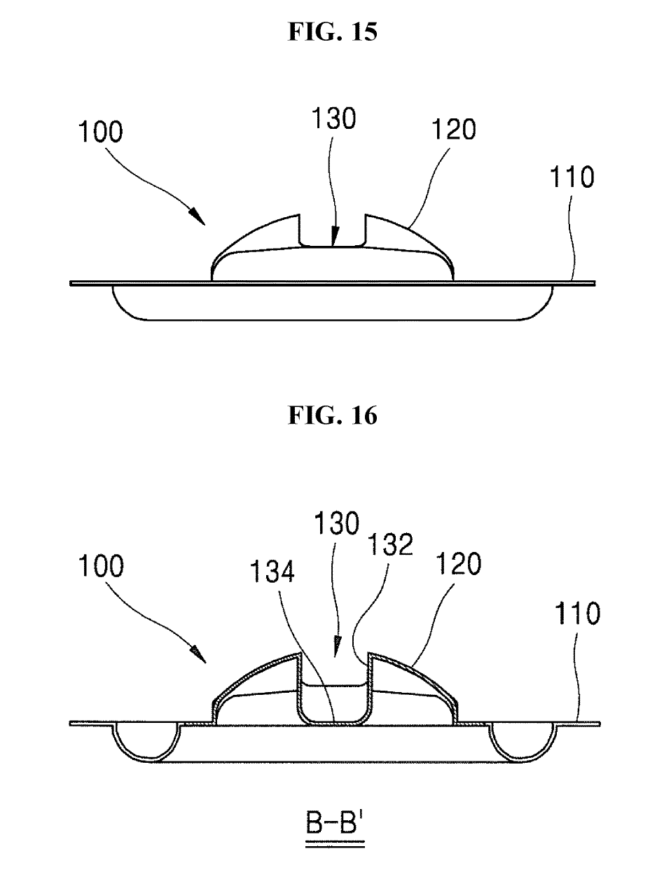

Next, a second embodiment of the diaphragm for the speaker apparatus according to the present invention will be described. In order to avoid redundancy, the description of the elements in the first embodiment will be omitted. FIG. 9 is a top-side view of a diaphragm for a speaker apparatus according to a second embodiment of the present invention, and FIG. 10 is a bottom-side view of the diaphragm according to the second embodiment of the present invention. FIG. 11 is a top view of the diaphragm according to the second embodiment of the present invention, FIG. 12 is a side view of the diaphragm according to the second embodiment of the present invention, and FIGS. 13 and 14 cross-sectional view of the diaphragm according to the second embodiment of the present invention (taken along line A-A′). FIG. 15 is a front view of the diaphragm according to the second embodiment of the present invention, and FIG. 16 is a front sectional view of the diaphragm according to the second embodiment of the present invention (taken along line B-B′).

The diaphragm 100 for the speaker apparatus according to the second embodiment of the present invention also has a substantially rectangular or track shape having a major axis and a minor axis perpendicular to the major axis. However, in comparison with the first embodiment, the diaphragm of the second embodiment has a partially cut extension extending outward from a part of the edge portion 110 extending along the major axis. This configuration is intended to provide a damping force to the vibration surface of the diaphragm and to further suppress the break-up mode vibration.

The convex portion 120 positioned inside the edge portion 110 is formed to be convex upward of the sound generating surface of the diaphragm 100, and the concave portion 130 positioned inside the convex portion is formed to be concavely extend from the convex portion when viewed from a side. The width of the concave portion is uniform along the major axis except for both ends of the concave portion.

Referring to FIG. 14, the difference d₁ between the height h_{1-H} of the highest point of the convex portion 120 and the height h_{1-L} of the lowest point of the concave portion 130 in the central area on the major axis is larger than the difference d₂ between the height h_{2-H} of the highest point of the convex portion 120 and the height h_{2-L} of the lowest point of the concave portion 130 in the outer area on the major axis from which the concave portion 130 begins to extend. Here, the position at which the smallest difference in height between the highest point of the convex portion 120 and the lowest point of the concave portion 130 is given is in the outer area on the major axis from which the concave portion 130 begins, and the position at which the largest difference in height between the highest point of the convex portion 120 and the lowest point of the concave portion 130 is given is in the central area on the major axis.

As shown in FIGS. 13 and 14, the difference in height between the highest point of the convex portion 120 and the lowest point of the concave portion 130 in the cross section taken along the minor axis (line B-B′) preferably decreases from the central area 141 to the outer area 142 along the major axis. As the height of the highest point of the convex portion 120 decreases from the central area 141 to the outer area 142, the convex portion 120 may be formed in the shape of a smooth convex curve having a convex central portion. On the other hand, as the height of the lowest point of the concave portion 130 increases from the central area 141 to the outer area 142, the concave portion 130 may be formed in the shape of a smooth concave curve having a concave central portion.

Referring to FIGS. 15 and 16, the convex portion 120 may include a first connector formed to have a smooth curve shape from the edge portion 110 to the highest point of the convex portion 120 in the cross section along the minor axis, and the concave portion 130 may include a second connector provided with a vertical surface portion from the highest point of the convex portion 120 to the lowest point of the concave portion 130 in the cross section along the minor axis. Particularly, when the vertical surface portion is formed in the second connector, the stiffness of the diaphragm may be further secured, and the break-up mode vibration may be further prevented.

As described above in relation to the first embodiment, the height of the lowest point of the concave portion 130 cannot be lowered infinitely, and the height of the lowest point of the central area is preferably equal to the height of the edge portion 110. In the second embodiment, in order to secure the maximize length of the vertical surface portion with the height of the lowest point of the concave portion determined as described above, the lowest point of the concave portion 130 constituting the second connector, may be provided with a horizontal portion 134, as shown in FIGS. 15 and 16. That is, the horizontal portion 134 is provided to secure the height of the vertical surface portion 132 as much as possible.

Hereinafter, the vibration characteristics of the conventional diaphragm 10 and the diaphragm 100 of the present invention will be described with reference to simulation data. In the simulation, the same material, size, applied pressure were given to the conventional diaphragm 10 and the diaphragm 100 of the present invention. Specifically, the length of the minor axis of the diaphragm 100 was set to 10 mm, and the length of the major axis was set to 71 mm. The material of the diaphragm 100 is set to polyethylene. As in the typical component speaker structure, the diaphragm 100 is surrounded by an edge of a TPU material and the bobbin having a diameter of 13 mm is coupled to the bottom of the diaphragm 100 and the voice coil wound around the bobbin is set to transfer a force of 10 kpa to an upper portion. FIG. 19 shows the upper portion of the conventional system of the diaphragm 10 used for stress simulation, and FIGS. 1 and 2 show the upper and lower portions of the system of the diaphragm 100 according to the present invention used for stress simulation.

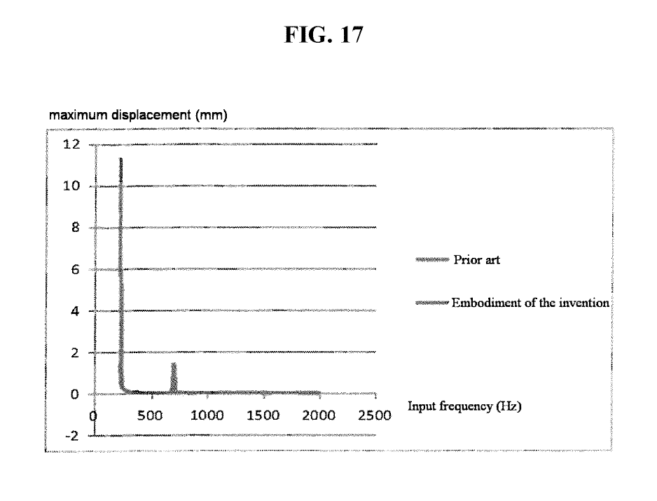

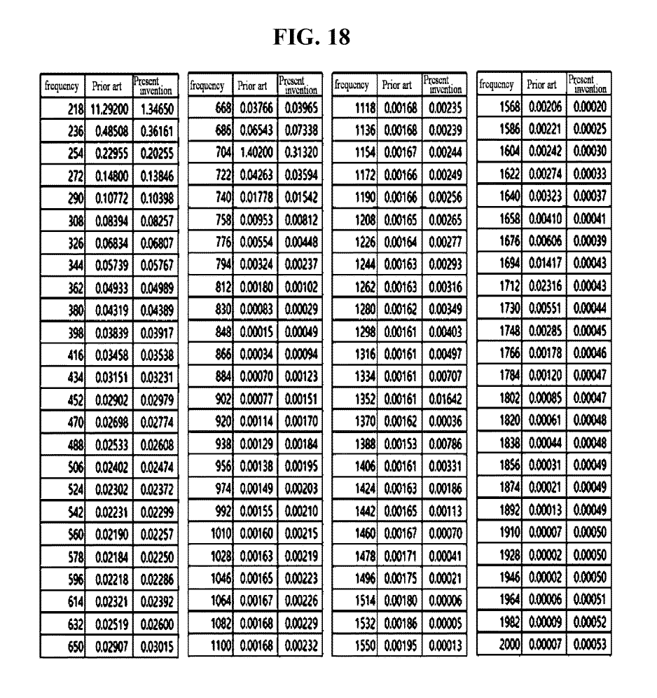

The results of the stress simulation are shown in Table 1 below. FIG. 17 shows a graph depicting the maximum displacements at each frequency, and FIG. 18 shows the maximum displacement values at each frequency.

TABLE 1

| | | | Diaphragm 100 | |
|---|---|---|---|---|
| | Prior art | | of the invention | |
| | Frequency | Displacement | Frequency | Displacement |
| First-order | 215 Hz | 11.292 mm | 214 Hz | 1.346 mm |
| resonance | | | | |
| mode | | | | |
| Second-order | 225 Hz | 7.891 mm | 234 Hz | 0.541 mm |
| resonance | | | | |
| mode | | | | |
| Third-order | 452 Hz | 0.029 mm | 446 Hz | 0.029 mm |
| resonance | | | | |
| mode | | | | |
| Fourth-order | 593 Hz | 0.022 mm | 660 Hz | 0.035 mm |
| resonance | | | | |
| mode | | | | |
| Fifth-order | 702 Hz | 1.402 mm | 683 Hz | 0.073 mm |
| resonance | | | | |
| mode | | | | |

The first-order resonance mode represents vibration in which the central portion of the diaphragm 100 repeats rising and falling according to the driving force of the voice coil. The second-order resonance mode represents vibration in which the side surfaces facing each other along the minor axis of the diaphragm 100 repeat rising and falling in the opposite directions. The third-mode resonance mode represents vibration in which the ends of the diaphragm 100 facing each other along the major axis of the diaphragm 100 repeat rising and falling in the opposite directions and the fourth-mode resonance mode represents torsional vibration along the minor axis of the diaphragm 100. The fifth-order resonance mode represents vibration in which the ends of the diaphragm 100 facing each other along the major axis of the diaphragm 100 repeat rising and falling in the same direction. The vibration of each mode is confirmed by stress simulation. The first-order, third-order and fifth-order resonance modes in which vibration occurs along the major axis are mainly affected by the bending stiffness of the diaphragm 100, while the second-order and fourth-order resonance modes in which vibration occurs along the minor axis are affected by the torsional stiffness of the diaphragm 100.

The resonance modes result from the resonance frequencies according to the material and shape of the diaphragm 100. Even if the same material is used, the maximum width of the vibration displacement varies at a specific frequency depending on the structural form of the diaphragm. Unlike the normal vibration caused by application of an audio signal, a resonance mode vibration resulting from a resonance frequency is relatively amplified regardless of the audio signal to distort the sound output. Accordingly, it is preferable to suppress the resonance mode vibration as much as possible.

It is confirmed from the table above that the stiffness enhancing structure according to the present invention has a maximum displacement that is only about 1/10 times the maximum displacement of the conventional simple track-shaped stiffness enhancing structure in the first-order and second-order resonance modes. Particularly, in the conventional diaphragm 10, the maximum displacement produced by the external force of 10 kPa at 215 Hz is 11.292 mm. On the other hand, the maximum displacement of the diaphragm 100 according to an embodiment of the present invention is as small as 1.346 mm. That is, the complementary shapes of the convex portion 120 and the concave portion 130 of the present invention enhance the bending stiffness of the diaphragm 100 along the major axis, thereby effectively suppressing the first-order resonance mode due to the break-up mode vibration. Further, the asymmetric shape of the first connector and the second connector may enhance the torsional stiffness of the diaphragm 100 along the minor axis, thereby effectively suppressing the second-order resonance mode.

### INDUSTRIAL APPLICABILITY

It is apparent that the disclosure above is industrially applicable.

1. A diaphragm for a speaker apparatus, the diaphragm having a shape with a major axis and a minor axis perpendicular to the major axis and comprising:
an edge portion;
a convex portion positioned inside the edge portion and formed to be convex upward; and
a concave portion positioned inside the convex portion and formed to be concave upward,
wherein, in a cross section taken along the minor axis, a difference in height between a highest point of the convex portion and a lowest point of the concave portion in a central area is larger than a difference in height between the highest point of the convex portion and the lowest point of the concave portion in an outer area on the major axis from which the concave portion begins.

2. The diaphragm according to claim 1, wherein a difference in height between the highest point of the convex portion and the lowest point of the concave portion at a position where the difference in height between the highest point of the convex portion and the lowest point of the concave portion is the smallest is less than 30% of a difference in height between the highest point of the convex portion and the lowest point of the concave portion at a position where the difference in height between the highest point of the convex portion and the lowest point of the concave portion is the largest.

3. The diaphragm according to claim 1, wherein the cross section taken along the minor axis comprises an interval in which the difference in height between the highest point of the convex portion and the lowest point of the concave portion is reduced from the central area to an outer side along the major axis.

4. The diaphragm according to claim 1, wherein, in the cross section taken along the minor axis, the height of the highest point of the convex portion in the central area is greater than the height of the highest point of the convex portion in the outer area on the major axis from which the concave portion begins.

5. The diaphragm according to claim 4, wherein, in the cross section taken along the minor axis, the height of the highest point of the convex portion decreases from the central area to an outer side along a major axis.

6. The diaphragm according to claim 1, wherein, in the cross section taken along the minor axis, the height of the lowest point of the concave portion in the central area is lower than the height of the lowest point of the concave portion in the outer area on the major axis from which the concave portion begins.

7. The diaphragm according to claim 6, wherein, in the cross section taken along the minor axis, the height of the lowest point of the concave portion increases from the central area to an outer side along the major axis.

8. The diaphragm according to claim 1, wherein the convex portion is formed in a smooth curve shape having a convex central portion in a cross section taken along the major axis.

9. The diaphragm according to claim 1, wherein the concave portion is formed in a smooth curve shape having a concave central portion in a cross section taken along the major axis.

10. The diaphragm according to claim 1, wherein the convex portion comprises a first connector formed in a smooth curve shape from the edge portion to the highest point of the convex portion in the cross section taken along the minor axis.

11. The diaphragm according to claim 10, wherein the concave portion comprises a second connector having at least an interval formed in a smooth curve shape between the highest point of the convex portion and the lowest point of the concave portion in the cross section taken along the minor axis.

12. The diaphragm according to claim 11, wherein the first connector has a radius of curvature greater than a radius of curvature of the second connector in the central area in the cross section taken along the minor axis.

13. The diaphragm according to claim 12, wherein the radius of curvature of the second connector increases from the central area to an outer side along the major axis.

14. The diaphragm according to claim 10, wherein the concave portion comprises a second connector provided with a vertical surface portion in at least an interval from the highest point of the convex portion to the lowest point of the concave portion in the cross section taken along the minor axis.

15. The diaphragm according to claim 14, wherein the lowest point of the concave portion in the cross section taken along the minor axis is provided with a horizontal portion.

16. The diaphragm according to claim 1, wherein the edge portion is substantially planar, and the height of the lowest point of the concave portion is greater than or equal to the height of the edge portion.

17. The diaphragm according to claim 16, wherein the height of the lowest point of the concave portion in the central area is equal to the height of the edge portion, and the height of the lowest point in areas other than the central area along the major axis is greater than the height of the edge portion.
